(19) United States
(12) Patent Application Publication
(10) Pub. No.: US 2006/0078855 A1
(43) Pub. Date: Apr. 13, 2006

(54) Teaching method and kit for abstract pattern drawing

(76) Inventors: Maria A. Thomas, Whitinsville, MA (US); Richard N. Roberts, Whitinsville, MA (US)

Correspondence Address: Richard L. Sampson;SAMPSON & ASSOCIATES, P.C., 50 Congress Street, Boston, MA, 02109, US

(21) Appl. No.: 11/229,928

(22) Filed: Sep. 19, 2005

Related U.S. Application Data
(60) Provisional application No. 60/611,896, filed on Sep. 21, 2004.

(51) Int. Cl. G09B 11/00

(52) U.S. Cl. 434/81

(57) ABSTRACT

A kit and teaching method for creating an artwork includes instructing the user to mark a surface with a line to divide the surface into sections, and to draw a pattern or patterns from provided samples within one of the sections. The user is then instructed to repeat this pattern in one or more other sections.

This application claims priority to U.S. Provisional Patent Application No. 60/611,896 entitled Teaching Method and Kit for Abstract Pattern Drawing, filed on Sep. 21, 2004.

### BACKGROUND

1. Technical Field

This invention relates to a teaching method for creative drawing, and more particularly to a kit and structured method of drawing an abstract design, which induces relaxation and a sense of calm in the user.

2. Background Information

Throughout this application, various publications, patents and published patent applications are referred to by an identifying citation. The disclosures of the publications, patents and published patent applications referenced in this application are hereby incorporated by reference into the present disclosure.

Amateur artists may benefit from having a structured method, in a prescribed format, by which artwork may be created incrementally, through a series of simple steps. It may also be beneficial to the user if the individual artworks were in a format which would allow the assembly of individual artworks into a collage or album. Still further, it may be beneficial to the user if the process could be completed within a short time period, thus creating a sense of success and completion. Ideally, the finished artwork should be entirely of the user's making, creating a sense of accomplishment in the user as well as encouraging creativity and artistic skills.

Current art kits tend not to provide these advantages. Atkinson, U.S. Pat. No. 5,304,064, discloses a game which provides objects to be drawn, such as parts of a rabbit's face. The object to be drawn depends on a roll of dice or another selection device. It does not provide abstract designs, and does not allow the user to choose what to draw. It also does not provide instruction on how to draw the object.

Some kits contain systems for creating art, but do not involve a structured method for creating of an entirely original work through simple steps. For example, Fromm, U.S. Pat. No. 5,435,240, discloses a children's pad printing kit in which images are traced, drawn, or stenciled, and transferred to another surface with a transfer pad. It does not contain guidance on the creative process. Harper, U.S. Pat. No. 4,836,783, discloses an activity kit for children, which includes a paper roll for the children to write on and possibly stencils and writing instruments. It also does not provide a specific method for creating works of art. Jonesi, U.S. Pat. No. 3,605,287, discloses an amusement and teaching device for children in which a picture is attached to a backing through eyelet holes, and does not involve drawing an original work.

Other drawing kits do not allow the freehand drawing of abstract patterns. Knecht, U.S. Pat. No. 1,753,344, discloses a method of producing drawings patented in 1926. It involves drawing lines between specified points in order to complete a drawing of a predetermined object, but does not allow freehand drawing. Cook, U.S. Pat. No. 3,364,598, discloses a method for tracing outlines of pictures onto colored sheets and assembling the sheets as a composite picture, and also does not allow freehand drawing.

Swartz, U.S. Patent Publication 2004/0063077 is a published application for a system of understanding of visual art, containing a set of cards, with artwork on one side of the card and information about the art on the other side of the card. It does not involve any creative drawing by the user.

Some collage kits also exist, but they too do not contain original drawings by the user. Kass, U.S. Pat. No. 3,574,017 discloses an ornamental system in which objects are glued to a background to form a composite picture. Bish, U.S. Pat. No. 3,581,882 is a collage art kit in which pictures are affixed to a backing to create a collage. Link, U.S. Pat. No. 6,663,732, discloses a process for making a puzzle collage, where photos are attached to pieces of a jigsaw puzzle and assembled into a collage. Lastoria, U.S. Pat. No. 6,273,979, discloses a method for making a combination mosaic and collage of photographs. Lariviere, U.S. Pat. No. 5,865,928, discloses a method of making collage puzzle pieces, but not of individualized pieces of art to make up the collage.

Thus, a need exists for a highly structured method, in a prescribed format which can also be made available as a kit, of creating abstract works of art of the user's own design, through incremental steps and individual drawing strokes, in such a way as to encourage calm, focus and relaxation in the user.

### SUMMARY

An aspect of this invention involves a method for instructing a user in the creation of a work of art. This method includes instructing the user to use a marking device to draw one or more lines on a marking surface, dividing the marking surface into a plurality of distinct sections. The user is then instructed to draw one or more patterns in the form of an orderly sequence of repetitive strokes, within one of the sections, bordered by one or more lines. The pattern or patterns would be chosen from a predetermined selection of patterns. The user is then instructed to draw one or more other patterns in another of the sections, wherein the patterns are bordered by one or more of the lines.

Another aspect of this invention involves a method of creating a work of art. The user begins by drawing one or more lines on a marking surface, dividing the marking surface into a plurality of distinct sections. The user draws one or more patterns, chosen from a predetermined selection of patterns, in the form of an orderly sequence of repetitive strokes, within one of the sections bordered by one or more of the lines. The user draws one or more other patterns in another of the sections, where the patterns are bordered by one or more of the lines.

Another aspect of this invention involves a kit for the creation of abstract artwork, including a marking surface, a temporary marking device, a permanent marking device, a set of sample lines and patterns, and a set of instructions. The instructions include instructing the user to use a marking device to draw one or more lines which divide a marking surface into a plurality of distinct sections, and instructing the user to draw one or more patterns, in the form of an orderly sequence of repetitive strokes, placed within one of the sections bordered by one or more of the lines. The user is then instructed to draw one or more other patterns in another of the sections, wherein the patterns are bordered by one or more of the lines.

### BRIEF DESCRIPTION OF THE DRAWINGS

The above and other features and advantages of this invention will be more readily apparent from a reading of the following detailed description of various aspects of the invention taken in conjunction with the accompanying drawings, in which:

FIG. 1 is a set of instructions of a representative embodiment of the present invention;

FIG. 2 is a graphical representation of part of the drawing process of a representative embodiment of the present invention;

FIG. 3 is a graphical representation of samples of strings of a representative embodiment of the present invention;

FIG. 4 is a graphical representation of samples of tangles of a representative embodiment of the present invention;

FIGS. 5A-5D are graphical representations of parts of a process of drawing a tangle on a tile of a representative embodiment of the present invention;

FIG. 6 is a graphical representation the process of adding shading to a tile of a representative embodiment of the present invention;

FIG. 7 is a graphical representation of samples of completed tiles of a representative embodiment of the present invention; and

FIGS. 8A and 8B are schematic representations of various components included in a kit version of the present invention.

### DETAILED DESCRIPTION

In the following detailed description, reference is made to the accompanying drawings that form a part hereof, and in which is shown by way of illustration, specific embodiments in which the invention may be practiced. These embodiments are described in sufficient detail to enable those skilled in the art to practice the invention, and it is to be understood that other embodiments may be utilized. It is also to be understood that structural, procedural and system changes may be made without departing from the spirit and scope of the present invention. The following detailed description is, therefore, not to be taken in a limiting sense, and the scope of the present invention is defined by the appended claims and their equivalents. For clarity of exposition, like features shown in the accompanying drawings shall be indicated with like reference numerals and similar features as shown in alternate embodiments in the drawings shall be indicated with similar reference numerals.

Where used in this disclosure, the term, “border” when used in connection with an element described herein refers to a series of lines which a user may employ to delineate or define the area within which subsequent marks will be made. Similarly, a “tile” is any surface on which marks can be made. The term “string” when used in connection with an element described herein, refers to one or more curved or straight lines drawn alone or in combination on the tile. The term “tangle” refers to a pattern drawn by the user as discussed herein. A “pencil” and a “pen” can be any marking device. A “section” refers to a part of the tile delineated by the string itself and/or in combination with the border. “Shading” refers to darkening a portion of one or more sections of the tile.

Briefly, embodiments of the present invention include a kit and method for creating artistic tiles in such a way to encourage relaxation and creativity. The user is guided through a process with simple steps toward drawing a design on the provided markable surface. The user is instructed to create a border on a markable surface. Within the border the user draws one or several lines which may be curved or straight, called a “string.” The user then draws a pattern, called a “tangle,” using repetitive strokes in the section created by the string to create an abstract design. The markable surface and the border within the markable surface create a finite space for the drawing of the pattern. This process may create a feeling of meditative relaxation and calm in the user.

An exemplary kit contains tools for making these tiles and includes a markable surface, a marking device, a set of sample strings and tangles, and a set of instructions. For example, a particular embodiment of the kit includes cotton mould-made paper tiles, in a square shape, measuring approximately 3.5 inches on each side; permanent markers (pens), non-permanent markers (pencils), a pencil sharpener, an instructional DVD, and an instruction manual entitled “Beginning Zentangle,” by Rick Roberts and Maria Thomas. The instruction manual outlines the steps to be taken to create the border, string, and tangle, and provides samples of each.

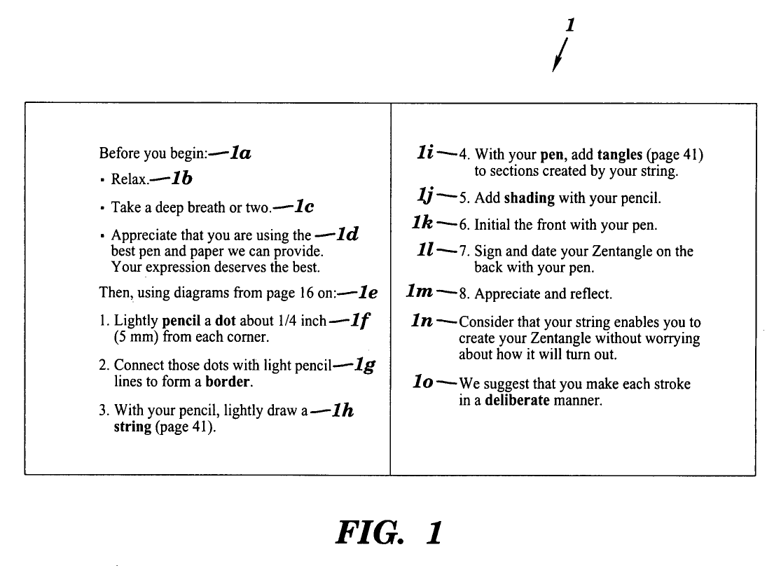

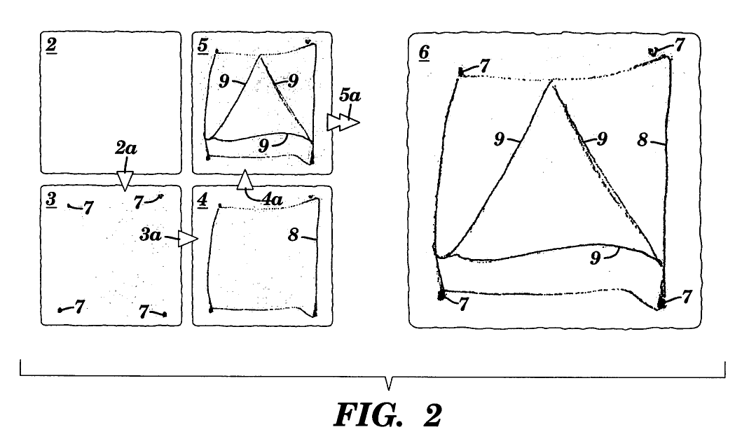

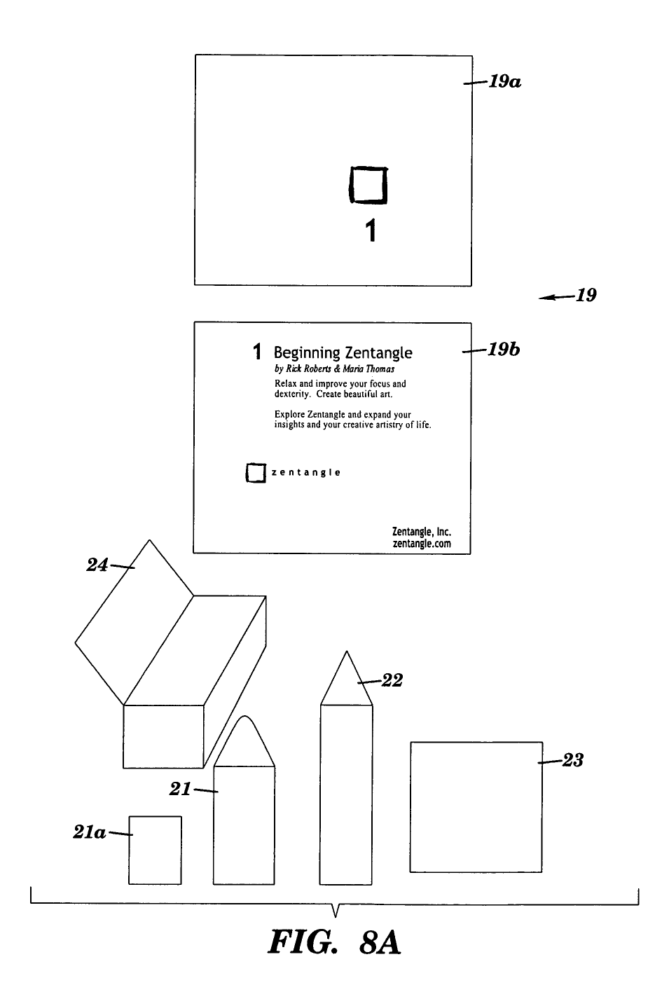

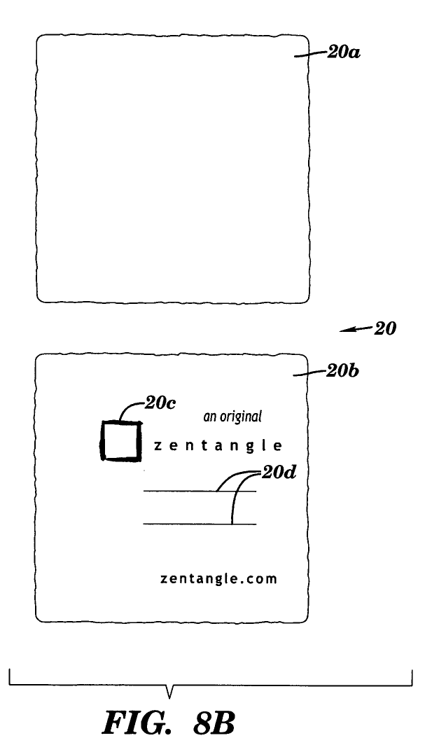

Referring now to the Figures, various aspects and embodiments of the present invention will be described in detail. Turning to FIGS. 1 and 2, an embodiment of the present invention includes a set of instructions 1. In this embodiment instructions 1 are from pages 14-15 of the instruction manual entitled “Beginning Zentangle,” as depicted in FIG. 1. FIG. 2 illustrates the process of drawing the border and the string within the border. In FIG. 1, the “Before you begin:” instructions 1a-1c are meant to encourage relaxation and calm in the user. For example, the user is instructed to relax 1b, and “take a deep breath or two” 1 c. The pen and paper 1d may be the permanent maker and paper provided as part of a kit, in FIGS. 8A, 8B at 20, 22.

The user begins with a blank tile, depicted as 2 in FIG. 2. FIG. 1 next contains an instruction to pencil a dot about 5 mm in from each corner 1f. The purpose of making the corner dots is to make beginning marks on the tile and to indicate the corners of the border, which will be drawn next. The dot may be marked diagonally inward from each corner. FIG. 2 depicts the tile 3 with the dots marked 7. The arrow 2a in FIG. 2 illustrates the step from a blank tile 2 to a tile 3 with four dots 7.

The instructions in FIG. 1 next instruct the user to connect the dots with light pencil lines to create a border 1g. The border indicates an area within which to draw strings. A border is depicted as 8 in tile 4 in FIG. 2. Arrow 3a in FIG. 2 instructs the user to proceed to tile 4 after completing tile 3.

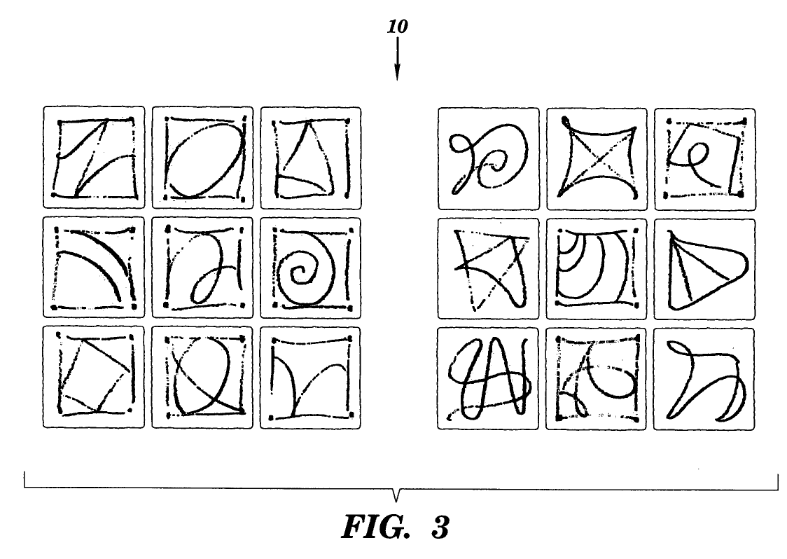

The user is instructed to connect the dots to form a border as shown as 4 in FIG. 2. The user is then directed to lightly draw a string 1h. Examples of strings 10 are provided in FIG. 3. The examples in FIG. 3 are meant to be illustrative only and are not meant to limit the types of strings included in this method. In one embodiment, the user is instructed to create his own strings. This helps the user to complete the tile without having to think about or plan the location of the different tangles. A tile 5 with a completed string 9 is shown in FIG. 2. Arrow 4a instructs the user to proceed from tile 4 (the border) to tile 5 (the string). Arrow 5a directs the user to a larger view of the steps completed thus far.

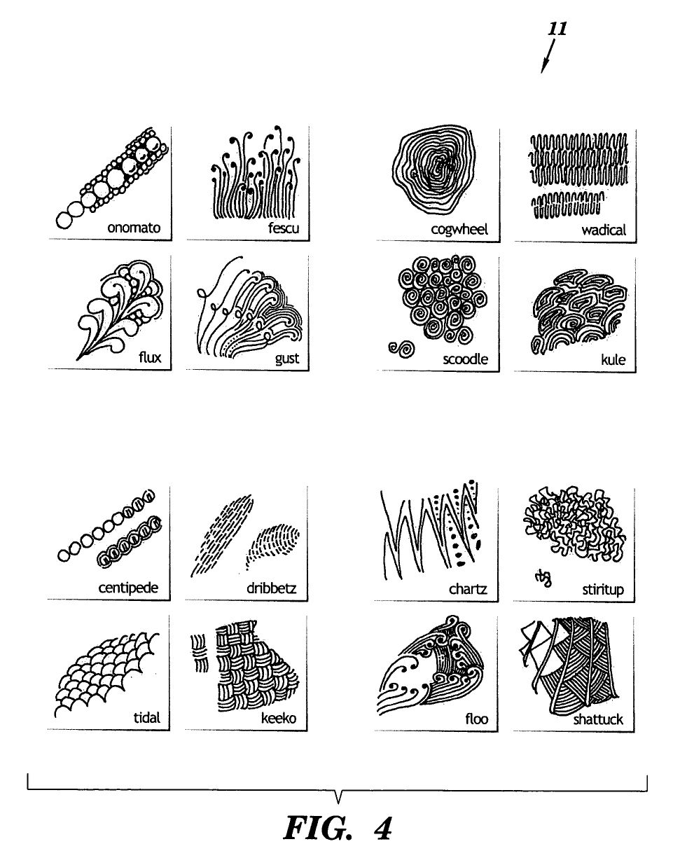

Instruction 1i of FIG. 1 instructs the user to use the pen to add tangles 11 to sections created by the string. Examples of tangles 11 in the manual are shown as FIG. 4. The examples in FIG. 4 are meant to be illustrative only and are not meant to limit the types of tangles included in this method. In one embodiment, the user is instructed to create his own tangles.

An embodiment may also contain an instruction to the user to focus only on the individual strokes of the pattern that makes up the tangle, rather than on planning ahead the overall outcome of the design. An embodiment may also include an instruction for the user to draw with his non-dominant hand, such that if the user is right-handed he would draw with his left hand. An embodiment may also include an instruction for the use to rotate the tile to the most comfortable orientation while drawing. Also, the user may be instructed to draw the individual strokes in the tangle pattern in a ‘deliberate’ manner (FIG. 1, 1o). In one embodiment, “deliberate” means drawing the strokes in an intentional, focused, and steady manner.

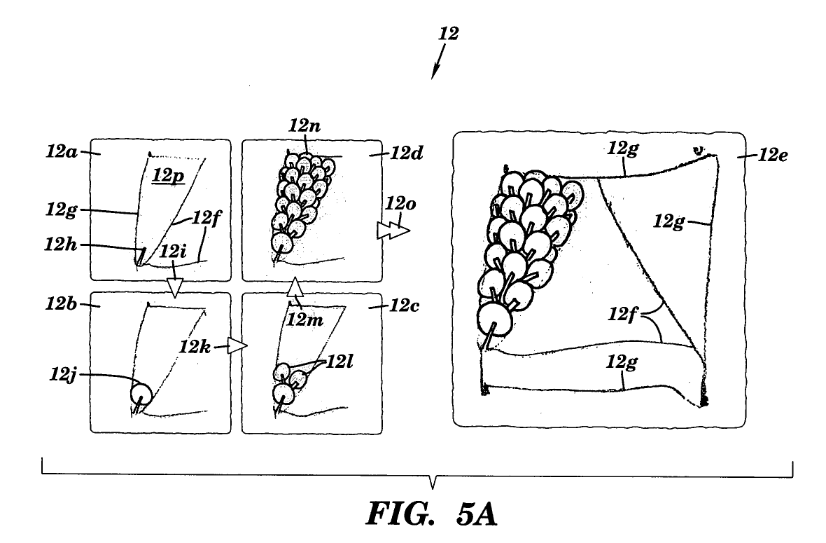

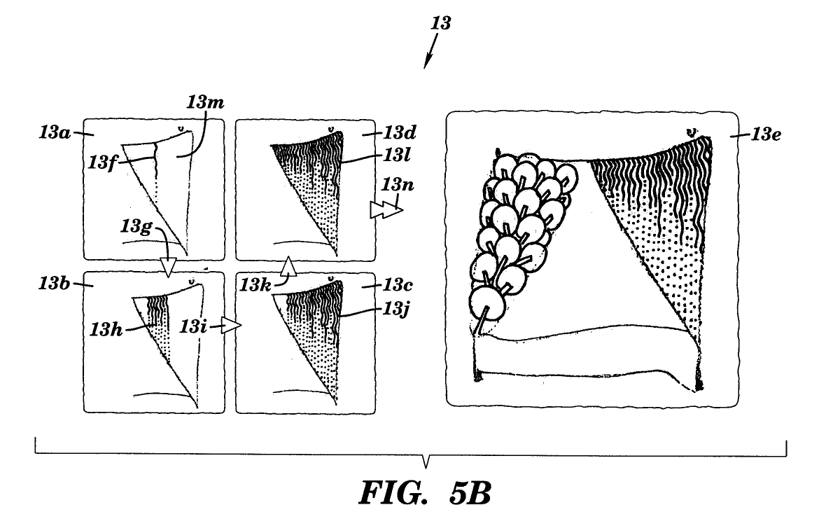

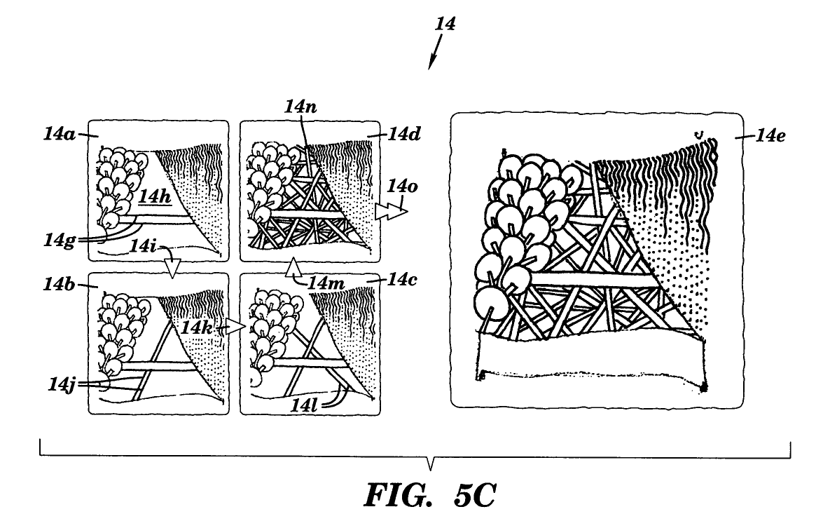

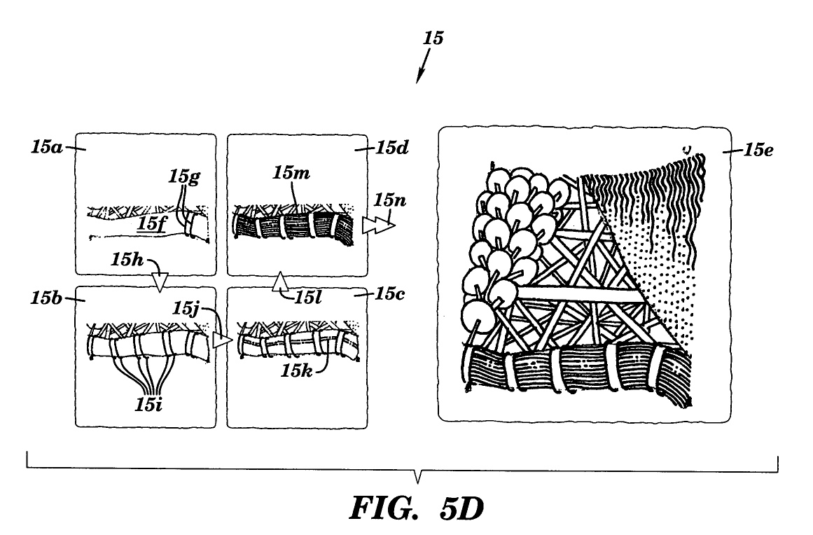

Examples of the process of drawing a tangle may be provided, as depicted in FIGS. 5A-5D. Any number of different tangles could be used. The examples in FIGS. 5A-5D are meant to be illustrative only and are not meant to limit the types of patterns included in this method.

FIG. 5A illustrates the process of drawing a tangle in the “poke-root” pattern 12. This process is diagrammed through examples of partial views of the tile at different steps in the process, respectively denoted as 12a-12d. 12e shows a full view of the tile. A string 12f has been drawn near a border 12g, creating section 12p. The first elemental stroke in the shape of three lines forming an open ended rectangle 12h has been drawn. The user is then directed by arrow 12i to examine the next stage in the drawing process 12b. This stage contains the addition of a circle 12j drawn behind the open ended rectangle 12h. Arrow 12k then directs the user to the next stage of the drawing 12c. In this stage, the same open-ended rectangle and circle pattern 121 is drawn above the original circle 12j.

Arrow 12m then directs the user to the next stage of the process 12d. In this stage, the open-ended rectangle and circle design is repeated many times 12n within the space 12p defined by the string 12f and border 12g. Arrow 12o then directs the user to tile 12e, where the finished “poke-root” design is illustrated.

FIG. 5B depicts the process for creating the “mist” design 13, using examples of partial views of tiles at different steps in the process, respectively denoted as 13a-13e. This design 13 is drawn in a different section of the same tile 12e on which the poke-root was drawn 12. In the first stage, a line is drawn from the upper part of the section, followed by dots in the same direction 13f. Arrow 13g then directs the user to the next stage of the “mist” drawing process 13b, where several more of the same line and dot 13f are drawn 13h. Arrow 13i then directs the user to the next stage, wherein more line and dot patterns are drawn 13j; and arrow 13k directs the user to the final stage 13d, where yet more line and dot patterns are drawn 131, filling the section 13m created by the line 12f within the border 12g.

Arrow 13n directs the user to tile 13e containing the completed “mist” pattern 13 as well as the poke-root pattern 12 created in FIG. 5A. The user may then move on to FIG. 5C for instruction on completing the “hollibaugh” pattern, as illustrated using tiles 14a-14e. A partial view of the tile with the already completed poke-root and mist patterns from FIGS. 5A and 5B is depicted in 14a. As shown, two horizontal parallel lines 14g are drawn across a section 14h defined by the string 12f. Arrow 14i leads to the next stage at 14b, in which a second set of parallel lines 14j cross behind the first set of lines. Arrow 14k then leads to tile 14c, where a third set of parallel lines 141 have been drawn, crossing behind the first two sets of lines. Arrow 14m leads to the completed tile 14d, where additional sets of two parallel lines have been drawn 14n, each set drawn behind the previous sets. Arrow 14o leads to a larger and complete view of the tile 14e containing the poke-root 12, mist 13, and hollibaugh 14 patterns.

Finally, FIG. 5D diagrams the addition of the “zander” pattern 15, as shown with partial views of tiles 15a-15d and complete view of tile 15e. A partial view of tile 14e is displayed in 15a. A section 15f is defined by the line 12f and the border. In section 15f a pair of two vertical parallel lines have been drawn 15g. These lines are curved in order to appear to be encircling section 15f. Arrow 15h leads to the next stage 15b, where several additional pairs of parallel lines 15i have been drawn. These additional pairs of lines are similar to the original pair of two lines. 15g Arrow 15j leads to the next stage 15c, wherein two horizontal lines 15k, are drawn crossing behind the vertical line pairs 15g, i. Arrow 15l leads to the last stage of the process 15d, where more horizontal parallel lines 15m, crossing behind the vertical lines 15g, i, have been added. Finally, arrow 15n leads to a complete view of the tile which contains the poke-root 12, mist 13, hollibaugh 14 and zander 15 patterns.

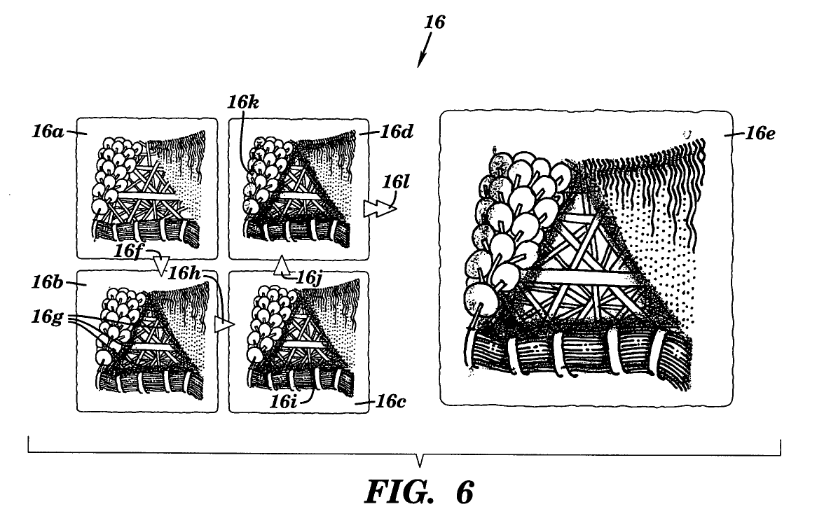

Instruction 1j of FIG. 1 instructs the user to add shading with a pencil. In one embodiment “shading” could be defined as penciled shades of grey within the tangle patterns. An example of adding shading to a tile as been provided in FIG. 6. FIG. 16a contains a tile with the same poke-root 12, mist 13, hollibaugh 14, and zander 15 patterns as shown in 15e. Arrow 16f leads to the first stage of the shading process in 16b. Part of the hollibaugh 14 pattern has been shaded by a transparent darkening of the tile 16g. The shading traces the perimeter of the section 14h. Arrow 16h leads to the next stage 16c, in which part of the zander 15 pattern has been shaded through a transparent darkening 16i along the bottom perimeter of section 15f. Arrow 16j leads to the next stage at 16d, in which a shading 16k of the poke-root pattern 12 has been added along the left perimeter of section 12p. Arrow 161 leads to an image of the tile 16e with the shading 16g, i, k completed.

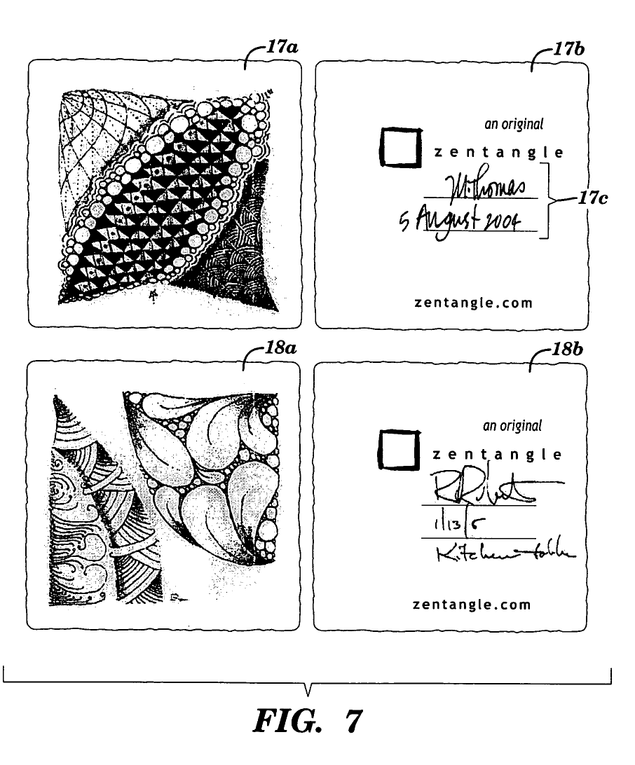

The user may choose to blend the shading by rubbing it with a finger. The user may also choose to initial the front of the tile with a marking device such as a pen (FIG. 1, 1k). The “front” of the tile refers to the surface of the tile on which the user draws the design, depicted as 20a in FIG. 8B. The user may then be instructed to sign and date the tile on the back. FIG. 1, 1l. Examples of completed tiles 17, 18 are provided in FIG. 7. The back of the tile 17 in FIG. 7 contains an example of a signature and dating of the tile, at 17c.

Turning to FIGS. 8A and 8B, an embodiment of the invention includes a kit having an instruction manual 19, an instructional DVD 23 which shows samples of some of the additional tangles suggested by the instructions, tiles 20, temporary markers 21, a sharpener for the temporary marker 21a, permanent markers 22, and reusable container 24 sized and shaped therefor.

Instruction manual 19 includes instructions 1a-1o, and samples of strings 10 and tangles 11-15. FIG. 8A shows the front 19a and back cover 19b of the instruction manual. The tile 20 in FIG. 8B is mould-made acid-free paper, approximately 3.5 inches square, with wavy edges. The wavy edges are die-cut with a custom die designed by the inventors. An example of this paper is Tiepolo paper manufactured by Fabriano paper mills in Italy. This paper is 290 grams per square meter. It is made of 100% cotton and contains a relatively smooth finish. While this paper is the preferred embodiment, other markable surfaces are also acceptable, including but not limited to fabric, stone, clay, metal, wood, plaster, digital media, and glass.

The front side of the tile 20a is the surface for the user to write on, and is initially blank. The back side of the tile 20b contains the Zentangle logo 20c and contains lines 20d which the user may use to initial or sign the work, write a title for the tile, date, or number the tile as part of a series or mosaic. The temporary marking device 21 (FIG. 8A) is intended to make temporary marks on the tile. A particular embodiment of the temporary marker is a soft black lead pencil. The temporary marking device should enable the user to make marks of varying degrees of density. The user should also be able to smudge the marks for the shading effect, as explained with respect to FIG. 6. The pencil sharpener 21a may be used to sharpen the pencil.

The permanent marking device 22 may be used to make permanent marks on the tile, and to make fine lines relative to the size of the marking surface. A particular embodiment of the permanent marker is a pen with black, archival quality ink. Archival quality ink is an ink which is resistant to temperature, humidity, light, and chemical agents such as acids or alkaline. An example of a suitable archival quality pen is the PIGMA® Micron pen, size 01 (Sakura Color Products Corp., Osaka, Japan).

In the embodiments shown and described herein, the tiles are sized and shaped to be conveniently hand-held. This advantageously provides a relatively high degree of portability, e.g., the tiles and markers may be conveniently carried in a pocket. The user may then implement various steps of the instant invention nominally anywhere, without the need for a desk, while simply holding the tile in the hand. Typically, the time required to complete such a hand-held tile is approximately fifteen minutes, but may be any amount of time, as the user may decide when to stop working on the tile. The user may be encouraged to repeat the tile making process thirty times in approximately thirty days. The user may combine the tiles to form a mosaic or an album. In a group setting, each member of the group may contribute one tile to the overall mosaic. The tiles could be framed, used as greeting cards, or used as templates for other works of art in different media.

Other benefits of this teaching method are manifold. The structured process allows the user to achieve a relaxed meditative state because the user does not have to plan the work in advance. The user is instructed that this is an abstract art form and the results need not represent a recognizable form and can be view from any orientation. Since the teaching method instructs the user to have no predetermined design outcome, the user can focus on individual strokes and not worry about the final appearance. The small size of the tile in one embodiment allows the user to complete a tile in a short period of time. The user is guided through the creative process in a prescribed format, using specific tools and completing the tile in a series of prescribed steps. The user can use the provided samples of strings and tangles. This allows the user to focus on the process of making patterns with deliberate strokes, rather than on inventing a new string or tangle. The user is encouraged to refrain from erasing any lines, and to instead use the “mistake” strokes as part of the developing pattern. The tools for the process are inexpensive and portable, so that the user can create the artwork in a variety of settings at the user's convenience.

The method may also provide psychological benefits, such as relief of stress and anxiety, improved self-esteem and a more positive outlook on life. The method may thus be used as therapy to improve the mental health of the user. Still further, the method may stimulate and encourage creativity in the user, and help improve eye-hand coordination and other artistic skills. To such an end the user may be instructed to experiment with drawing with both his dominant and non-dominant hands. The user may also be instructed to develop his own strings and tangles.

In the foregoing description, various patterns or tangles have been shown and described. The skilled artisan should recognize that these are merely representative, and that nominally any patterns may be used without departing from the spirit and scope of the present invention.

In the preceding specification, the invention has been described with reference to specific exemplary embodiments thereof. It will be evident that various modifications and changes may be made thereunto without departing from the broader spirit and scope of the invention as set forth in the claims that follow. The specification and drawings are accordingly to be regarded in an illustrative rather than restrictive sense.

Having thus described the invention, what is claimed is:

1. A method for creating an abstract artwork, comprising the steps of:
a) Instructing a user to mark dots around the inside perimeter of a marking surface, using a temporary marking device;
b) Instructing the user to connect the dots with the temporary marking device, creating a border around the inside perimeter;
c) Instructing the user to draw with the temporary marking device one or more lines within the border which create a section or sections within the border;
d) Instructing the user to choose one of a plurality of predetermined patterns, and to draw with a permanent marking device the chosen pattern within a chosen section defined within the border;
e) Instructing the user to make each stroke deliberate and intentional;
f) Instructing the user to choose another of the plurality of predetermined patterns, and to draw the other chosen pattern within another chosen section;
g) Reminding the user to watch the tile evolve;
h) Alerting the user that the patterns are all accomplished by a series of repetitive strokes, intended to deliberately capture the user's attention;
i) Alerting the user that the engagement of the hand and eye, in combination with the effect of the repetitive motions, enables a shift of focus and perspective, and relaxation;
j) Instructing the user to shade different areas of the tile using a pencil or other temporary marking device;
k) Instructing the user to blend the shading by rubbing with a fingertip;
l) Instructing the user to sign the tile with the permanent marking device;
m) Instructing the user to view and appreciate the new patterns and lines created that may not have been planned; and
n) Instructing a user to document a back side of the tile.

2. A method for teaching a user to create a work of art, the method comprising:
a) Instructing the user to use a marking device to draw one or more lines which divide a marking surface into a plurality of distinct sections;
b) Instructing the user to draw within one of the sections, one or more patterns chosen from a predetermined selection of patterns, the one or more patterns being in the form of an orderly sequence of repetitive strokes, wherein the one or more patterns are bordered by the one or more lines; and
c) Instructing the user to draw one or more other patterns in another of the sections,
wherein the one or more other patterns are bordered by the one or more lines.

3. The method of claim 2, wherein the one or more lines are curved.

4. The method of claim 2, wherein the marking surface comprises a material selected from the group consisting of paper, fabric, stone, clay, metal, plaster, glass, wood, computer drawing programs, and combinations thereof.

5. The method of claim 2, wherein the marking surface has a shape selected from the group consisting of polygons, arcs, intersecting polygons, intersecting arcs, and combinations thereof.

6. The method of claim 2, wherein the marking surface is flat.

7. The method of claim 2, wherein the marking surface is fabricated from a mould-made paper comprising cotton with a weight of at least 200 grams per square meter, and having a transverse dimension of at least approximately 3 inches.

8. The method of claim 2, wherein the marking surface is die cut with rounded corners and wavy edges.

9. The method of claim 2, wherein the marking device is selected from the group consisting of a stylus, a metal engraver, a pencil, a chisel, a brush, digital pointing device, and a pen.

10. The method of claim 2, wherein the user is instructed to create a border by connecting markings disposed in spaced relation about the marking surface to enclose the one or more sections.

11. A method of creating a work of art, comprising:
a) Using a marking device to draw one or more lines which divide said marking surface into a plurality of distinct sections;
b) Using a marking device to draw one or more patterns chosen from a predetermined selection of patterns in the form of an orderly sequence of repetitive strokes, within one of the sections, bordered by the one or more lines; and
c) Using a marking device to draw one or more other patterns in another of the sections; wherein the patterns are bordered by the one or more lines.

12. The method of claim 11, wherein the line is drawn with a temporary marker.

13. The method of claim 11, wherein the pattern is drawn with a permanent marker.

14. The method of claim 11, comprising applying shading to parts of the pattern.

15. The method of claim 14, comprising manually blending the shading.

16. The method of claim 11, comprising repeating said using (a) through said using (c).

17. The method of claim 11, comprising combining multiple marking surfaces to form a mosaic.

18. The method of claim 11, comprising placing the substrate into an object selected from the group consisting of a greeting card, a glass etching, a wall hanging, stationery, fabric pattern, clothing applique, decal, ceramic tile, laser cutting template, jewelry, dishes, pottery, wallpaper, and a template for works in other media.

19. A kit for the creation of abstract artwork, comprising:
a set of said instructions of claim 2;
a marking surface;
a temporary marking device;
a sharpener for the temporary marking device;
a permanent marking device; and
a set of sample lines and patterns.

20. The kit of claim 19, wherein:
said set of instructions include an instruction manual;
said marking surface includes a plurality of mould-made cotton paper tiles;
said temporary marking device includes one or more soft black pencils;
said temporary marking device includes a pencil sharpener;
said permanent marking device includes one or more archival quality pens;
and further comprising an instructional DVD.

21. The method of claim 2, wherein the marking surface is sized and shaped to be hand-held.
